(19) United States
(12) Patent Application Publication
(10) Pub. No.: US 2011/0115671 A1
(43) Pub. Date: May 19, 2011

(54) DETERMINATION OF ELEVATION OF MOBILE STATION

(75) Inventors: Charles Wheeler Sweet, III, San Diego, CA (US); Serafin Diaz Spindola, San Diego, CA (US)

(73) Assignee: QUALCOMM Incorporated, San Diego, CA (US)

(21) Appl. No.: 12/620,201

(22) Filed: Nov. 17, 2009

(51) Int. Cl. G01S 19/48; G01S 3/02

(52) U.S. Cl. 342/357.31; 342/451

(57) ABSTRACT

A mobile station determines it elevation based on the determined position of mobile station and a database of elevation data. The determined elevation of the mobile station may be used to vertically position a computer generated graphics in an image produced by the mobile station. In one embodiment, the elevation of the mobile station is determined by obtaining the elevation of multiple positions that define an area around the mobile station and using the elevation at the multiple positions to calculate the elevation at the current position.

### BACKGROUND

A common means to determine the location of a device is to use a satellite position system (SPS), such as the well-known Global Positioning Satellite (GPS) system or Global Navigation Satellite System (GNSS), which employ a number of satellites that are in orbit around the Earth. Position measurements using SPS are based on measurements of propagation delay times of SPS signals broadcast from a number of orbiting satellites to an SPS receiver. Once the SPS receiver has measured the signal propagation delays for each satellite, the range to each satellite can be determined and precise navigation information including 3-dimensional position, velocity and time of day of the SPS receiver can then be determined using the measured ranges and the known locations of the satellites.

Knowledge of the location of a device has many uses, one of which is known as augmented reality. Augmented reality combines real-world imagery with computer generated data, such as graphics or textual information. In order to properly align the computer generated data with the intended object in the image, the location of the imaging device must be known. When the imaging device has a fixed position, such as a television camera, the location of the imaging device can be easily determined. With a mobile device, however, the location must be tracked. The use of an SPS system, for example, may be used to track the location of a mobile device. Typically, however, the least accurate measurement in an SPS system is elevation. In augmented reality applications where geo-referenced computer graphics are overlaid on top of real-world imagery, elevation is just as important as latitude and longitude.

### SUMMARY

A mobile station produces an estimate of its elevation based on the measured latitude and longitude of the mobile station and an elevation database. The elevation of a mobile station may be determined by accessing a database to determine the elevation of multiple positions that define an area around the mobile station and calculating the elevation of the mobile station using the elevation of the multiple positions. The determined elevation of the mobile station may be used to vertically position a computer generated graphics in an image produced by the mobile station.

### BRIEF DESCRIPTION OF THE DRAWING

FIG. 1 illustrates a mobile station that determines its elevation using an online server based on a determined latitude and longitude.

FIG. 2 illustrates a block diagram showing a system in which a mobile station accesses a server via a network to obtain elevation data.

FIG. 3 is a block diagram of the mobile station that determines its elevation using an online server and uses the elevation to vertically position computer generated information on an image.

FIG. 4 is a flow chart showing a method of determining the elevation of the mobile station and displaying computer generated information on an image based on the elevation.

FIG. 5 illustrates obtaining elevation data for multiple locations surrounding the mobile station.

FIG. 6 illustrates another method of obtaining elevation data for multiple locations surrounding the mobile station.

FIG. 7 illustrates the determined orientation of the mobile station as a field of view of an image produced by the mobile station.

FIG. 8 illustrates an image that may be produced by the mobile station along with vertically positioned computer generated information.

### DETAILED DESCRIPTION

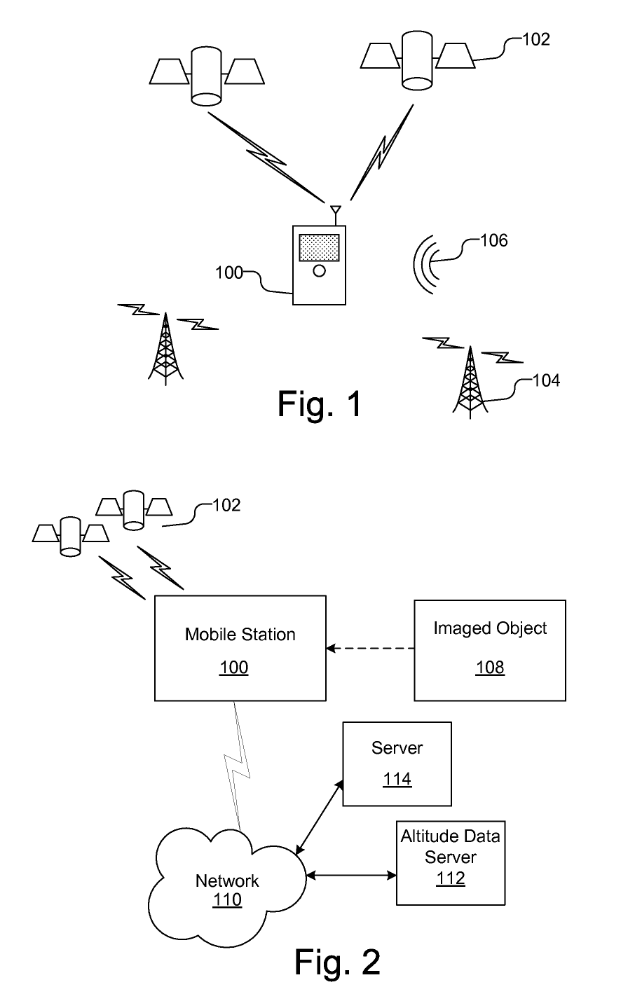

FIG. 1 illustrates a mobile station 100 that determines its latitude and longitude using a satellite positioning system (SPS), which includes satellite vehicles 102, and determines its elevation using a database, which may be stored in the mobile station 100 memory or on an online server accessed via cellular towers 104 and from wireless communication access points 106. The mobile station 100 uses its determined elevation along with the elevations of geo-referenced elements to be imaged, which are also stored, e.g., in the mobile station 100 memory or an online server, to display computer generated information on an image of the geo-referenced elements.

As used herein, a mobile station (MS) refers to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile station.”

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs) 102, illustrated in FIG. 1. For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass).

In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The mobile station 100, however, is not limited to use with an SPS, but position determination techniques described herein may be implemented in conjunction with various wireless communication networks, including cellular towers 104 and from wireless communication access points 106, such as a wireless wide area network (WWAN), a wireless local area network (WLAN), a wireless personal area network (WPAN), and so on. Alternative methods of position determination may also be used, such as object recognition using “computer vision” techniques. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

FIG. 2 illustrates a block diagram showing a system in which a mobile station 100 acquires positional information, e.g., latitude and longitude, from a constellation of satellite vehicles 102 in an SPS. As illustrated, the mobile station 100 produces an image of an object 108. The mobile station 100 accesses a network 110, e.g., via cellular tower 104 or wireless access point 106, illustrated in FIG. 1. The network 110 is coupled to a server 112, which stores elevation data. By way of example, the server 112 may store GIS elevation data. The mobile station 100 queries the server 112 to obtain elevation data from which the mobile station 100 may determine its current elevation. The same server 112 or a different server 114 may be queried to determine the elevation of the imaged object 108. With the elevations of the mobile station 100 and the imaged object 108 known, the mobile station 100 may generate computer generated data, e.g., graphics or textual information, that is displayed on the image in the appropriate vertical position. It should be understood that if desired the mobile station 100 may acquire position information using methods other than an SPS system and may obtain elevation data from internal memory as opposed to querying servers 112 and 114.

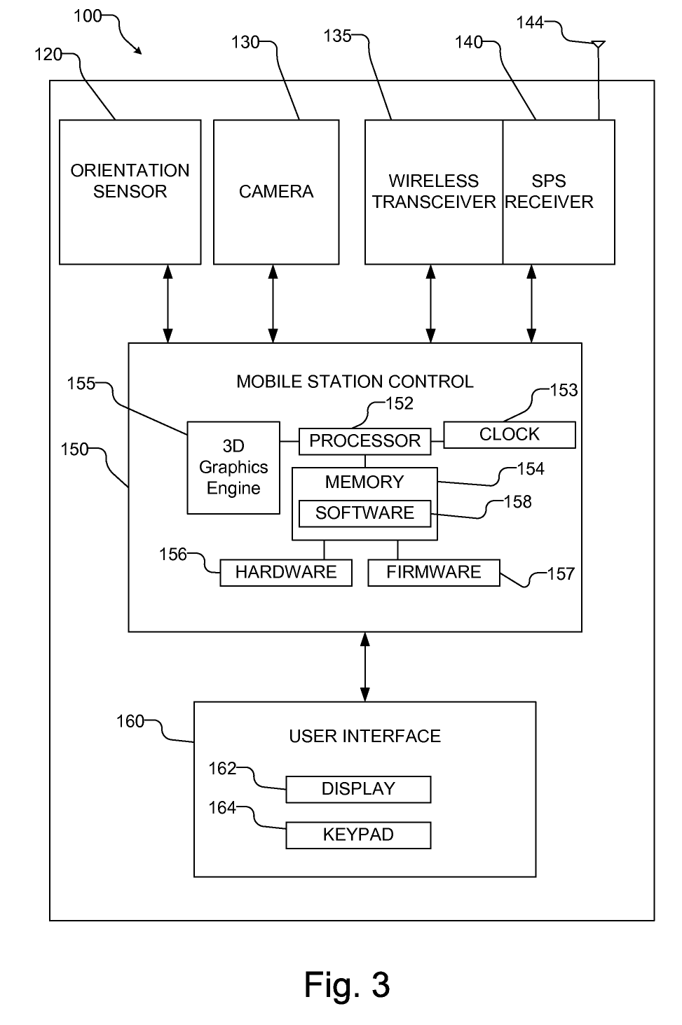

FIG. 3 is a block diagram of the mobile station 100. As illustrated in FIG. 3, the mobile station 100 includes an orientation sensor 120, which may be, e.g., a tilt corrected compass including a magnetometer, accelerometer or gyroscope. The mobile station also includes a camera 130, which may produce still or moving images that are displayed by the mobile station 100.

Mobile station 100 may include a receiver 140, such includes a satellite positioning system (SPS) receiver that receives signals from a SPS satellites 102 (FIG. 1) via an antenna 144. Mobile station 100 also includes a wireless transceiver 135, which may be, e.g., a cellular modem or a wireless network radio receiver/transmitter that is capable of sending and receiving communications to and from a cellular tower 104 or from a wireless access point 106, respectively, via antenna 144 (or a separate antenna). If desired, the mobile station 100 may include separate transceivers that serve as the cellular modem and the wireless network radio receiver/transmitter.

The orientation sensor 120, camera 130, SPS receiver 140, and wireless transceiver 135 are connected to and communicate with a mobile station control 150. The mobile station control 150 accepts and processes data from the orientation sensor 120, camera 130, SPS receiver 140, and wireless transceiver 135 and controls the operation of the devices. The mobile station control 150 may be provided by a processor 152 and associated memory 154, a clock 153, hardware 156, software 158, and firmware 157. The mobile station 150 may include a graphics engine 155, which may be, e.g., a gaming engine, which is illustrated separately from processor 152 for clarity, but may be within the processor 152. The graphics engine 155 calculates the position of the computer generated information that is displayed on an image produced by the camera 130. It will be understood as used herein that the processor 152 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile station, and is not to be limited to any particular type of memory or number of memories, or type of media upon which memory is stored.

The mobile station 100 also includes a user interface 160 that is in communication with the mobile station control 150, e.g., the mobile station control 150 accepts data and controls the user interface 160. The user interface 160 includes a display 162 that displays images produced by the camera 130 along with overlaid computer generated data produced by processor 152. The processor 152 controls the position of the computer generated data on the image based on the elevations of the objects in the image and the elevation of the mobile station 100. The display 162 may further display control menus and positional information. The user interface 160 further includes a keypad 164 or other input device through which the user can input information into the mobile station 100. In one embodiment, the keypad 164 may be integrated into the display 162, such as a touch screen display. The user interface 160 may also include, e.g., a microphone and speaker, e.g., when the mobile station 100 is a cellular telephone.

The methodologies described herein may be implemented by various means depending upon the application. For example, these methodologies may be implemented in hardware 156, firmware 157, software 158, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 154 and executed by the processor 152. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

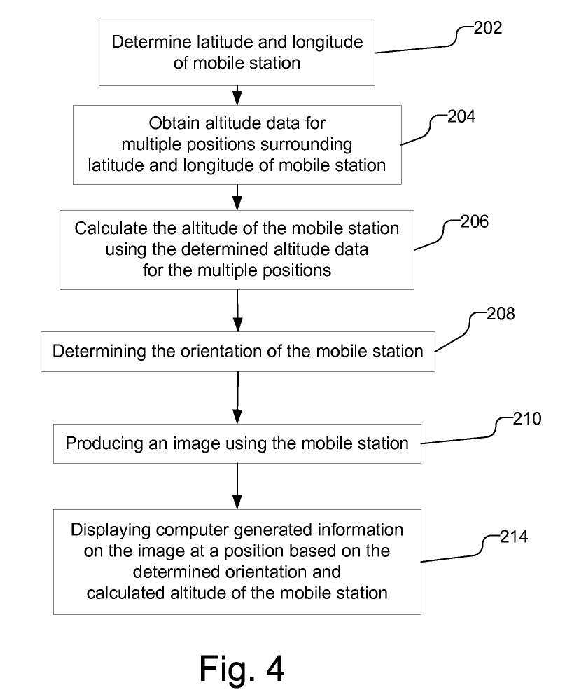

FIG. 4 is a flow chart showing a method of determining the elevation of the mobile station and displaying computer generated information on an image based on the elevation. As illustrated in FIG. 4, the position, e.g., latitude and longitude, of the mobile station is determined (202). The position may be determined using an SPS system, e.g., data from a SPS system is received by the SPS receiver 140 (FIG. 3) from which processor 152 calculates the position. If desired, the position may be determined using other techniques and devices including using data from other various wireless communication networks, including cellular towers 104 and from wireless communication access points 106 or by object recognition using computer vision techniques. Generally, an SPS system will provide elevation information. However, the elevation information is relatively inaccurate for use in applications such as augmented reality. Accordingly, a more accurate measurement of the elevation of the mobile station 100 needs to be determined.

To determine the elevation of the mobile station 100, elevation data is obtained for multiple positions that define an area that includes the longitude and latitude of the mobile station 100 (204). The elevation data may be obtained via server 112 in network 110, shown in FIG. 2, which is accessed and queried with the wireless transceiver 135, shown in FIG. 3. Alternatively, the mobile station 100 may obtain the elevation data from a database that is stored in memory 154 of the mobile station 100. In one embodiment, the elevation data for the determined position of the mobile station 100 may be obtained instead of obtaining elevation data for multiple positions surrounding the mobile station 100. However, using the determined position of the mobile station 100 would require a larger database and would increase latency as the elevation data would be continually updated as the mobile station moves.

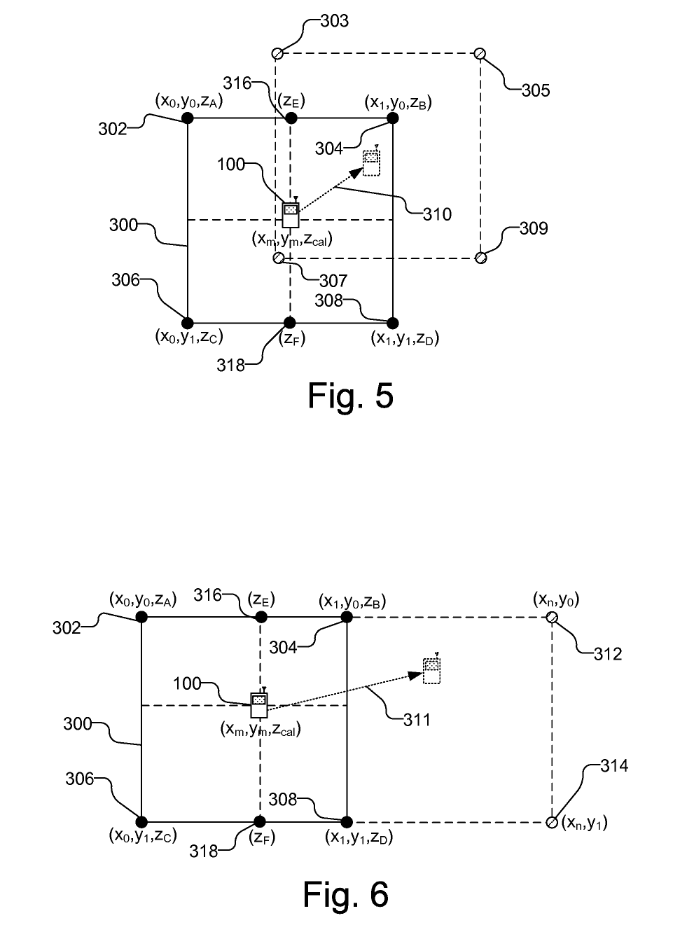

FIG. 5 illustrates obtaining elevation data for multiple locations 302, 304, 306, and 308 surrounding the mobile station 100. The locations surrounding the mobile station 100 may be determined based on the determined position of the mobile station 100. For example, four surrounding locations may be used, where the positions of the four surrounding locations are determined by adding and subtracting a distance from the x and y positions of the mobile station position to produce a square centered on the mobile station. For example, if the area 300 is to be 20 m per side, the positions of locations 302, 304, 306, and 308, may be (x₀,y₀)=(xₘ−10,yₘ+10); (x₁,y₀)=(xₘ+10,yₘ+10); (x₀,y₁)=(xₘ−10,yₘ−10); and (x₁,y₁)=(xₘ+10,yₘ−10), respectively. The server 112, which includes a database elevation data, such as GIS elevation data, may then be queried based on the multiple positions to determine the elevations of the locations 302, 304, 306, and 308, which are illustrated in FIG. 5 as z_{A}, z_{B}, z_{C}, and z_{D}, respectively. Thus, if mobile station 100 is anywhere within area 300 shown in FIG. 5, the same locations 302, 304, 306, and 308 are used to define the surrounding area. When mobile station 100 moves to or near the boarder of the area 300, i.e., moves approximately 10 m in either the x or y directions in this example as illustrated by the dotted line 310, four new locations 303, 305, 307, and 309 surrounding the mobile station 100 may be determined based on the current position of the mobile station 100.

Alternatively, the locations surrounding the mobile station 100 may be determined based on a fixed grid and the position of the mobile station within the fixed grid. For example, a grid may be constructed with the nodes at the nearest ±⅙ second of latitude and longitude, which will produce an area 300 that is roughly 30 feet per side. If desired, the size of area 300 may have a larger or smaller size. The position of the mobile station 100 (xₘ,yₘ) within the grid can be determined by rounding the determined latitude of the mobile station 100 to the nearest ±⅙ second of latitude and longitude to determine the positions of locations 302, 304, 306, and 308 are illustrated in FIG. 6 as coordinates (x₀,y₀), (x₁,y₀), (x₀,y₁), (x₁,y₁). The server 112, which includes a database elevation data, such as GIS elevation data, may then be queried based on the multiple positions to determine the elevations of the locations 302, 304, 306, and 308, which are illustrated in FIG. 6 as z_{A}, z_{B}, z_{C}, and z_{D}, respectively. Thus, if mobile station 100 is anywhere within area 300 shown in FIG. 6, the same locations 302, 304, 306, and 308 are used to define the surrounding area. When mobile station 100 moves outside of area 300, as illustrated by the dotted line 311, the positions of at least two new nodes in the grid, e.g., locations 312 (xₙ,y₀) and 314 (xₙ,y₁), must be determined and their elevation obtained.

Referring back to FIG. 4, the elevation of the mobile station 100 is then calculated based on the elevation data obtained for the multiple positions surrounding the mobile station 100 (206). By way of example, the elevation of the mobile station 100 may be calculated using a multivariate interpolation or spatial interpolation, such as bilinear interpolation. Bilinear interpolation is similar to linear interpolation, but is performed for one direction, then in the other direction. For example, referring to FIGS. 5 and 6, bilinear interpolation may be performed by first using linear interpolation in the X direction between locations 302 and 304 to calculate the elevation z_{E} at location 316 and between locations 306 and 308 to calculate the elevation z_{F} at location 318. The linear interpolation is then performed in the Y direction between locations 316 and 318 to calculate the elevation (z_{cal}) at mobile station 100. Other methods of determining the elevation at mobile station 100 based on the known elevations of the surrounding locations may be used if desired, including bicubic interpolation or Bezier surface.

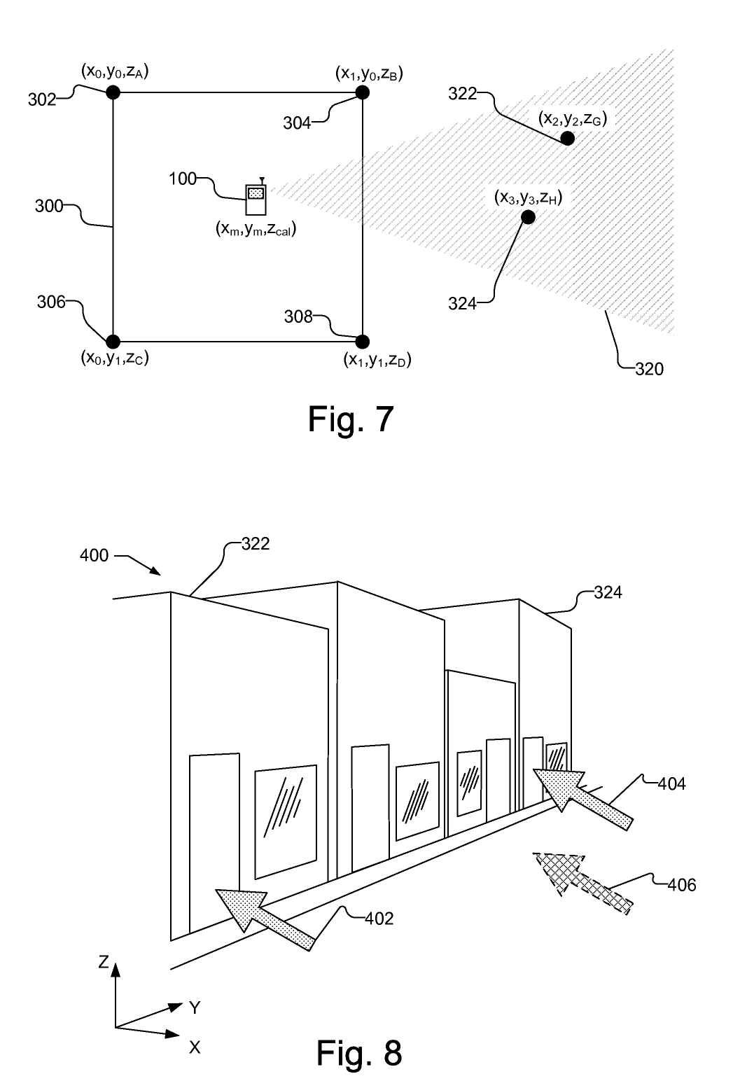

The orientation of the mobile station is determined (208) and an image is produced (210), e.g., using the orientation sensor 120 and camera 130, respectively, shown in FIG. 3. FIG. 7 is similar to FIG. 5, like designed elements being the same, but FIG. 7 illustrates the determined orientation of the mobile station 100 as the field of view 320 of an image produced by the mobile station 100. As illustrated in FIG. 7, the field of view 320 may include objects 322 and 324, which are part of the image produced by the mobile station 210.

FIG. 8 illustrates an image 400 that may be produced by the mobile station 100, including objects 322 and 324, which are illustrated as buildings. The image 400 shows a portion of a street that is on an incline, i.e., the objects 322 and 324 are at different elevations. Additionally, the image 400 is affected by foreshortening. To produce computer generated information in an image, the foreshortening must be considered. Current graphic or gaming engines can be used to accurately position computer generated information on an image, such as image 400, if the positions of the objects 322 and 324 relative to the camera 130 are known. Accordingly, the positions of the objects 322 and 324 are determined by the mobile station 100, e.g., by accessing a database stored in memory 154 of the mobile station 100 or by accessing server 112 and/or 114 on the network 110 (FIG. 2).

In one example, a user may indicate via control menus and keypad 164 that a specific type of information, such as restaurants, is displayed on the image 400. The mobile station 100 may then retrieve from a server 114 restaurants that are near the mobile station 100 based on the determined position of mobile station 100. Further, based on the determined orientation of the mobile station 100, restaurants that are in the field of view 320 of the camera 130 may be determined. The position, e.g., latitude and longitude, of the restaurants may be included in the search results. In one embodiment, the coordinates determined for the objects, e.g., restaurants in the present example, may include an accurate elevation for the objects. In another embodiment, the elevation of the objects may be calculated in a manner similar to the calculation of the elevation of the mobile station 100, e.g., using a multivariate interpolation based on known elevations of locations surrounding the objects. As illustrated in FIG. 7, the objects 322 and 324 are determined to have coordinates (x₂,y₂,z_{G}) and (x₃,y₃,z_{H}), respectively.

With the positions, including the elevations, of the objects 322 and 324 and the mobile station 100 determined, the desired computer generated information may be displayed on the image 400 using the graphics engine 155. For example, in FIG. 8, computer generated information is illustrated as arrows 402 and 404 that indicate the location of objects 322 and 324. The computer generated information, however, may be any form of graphical or textual information. With the elevation of the mobile station 100 calculated and the elevations of objects 322 and 324 determined the computer generated information 402 and 404 can be displayed in the image 400 at the correct vertical position, e.g., along the Z coordinate shown in FIG. 8 for reference purposes and is not part of the image 400. By contrast, without an accurate determination of the elevation of the mobile station 100, the computer generated information may be displayed at an inaccurate vertical position, as illustrated by the hatched arrow 406.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method comprising:
determining a position of a mobile station;
accessing a database to determine the elevation of the mobile station based on the determined position;
producing an image using the mobile station; and
displaying computer generated information on the image, the vertical position of the computer generated information on the image is based on the determined elevation of the mobile station.

2. The method of claim 1, wherein accessing a database to determine the elevation of the mobile station based on the determined position comprises:
accessing a database to determine elevation data for multiple positions that define an area that includes the determined position of the mobile station;
calculating the elevation of the mobile station using the determined elevation data for the multiple positions.

3. The method of claim 2, wherein the elevation of the mobile station is calculated using bilinear interpolation.

4. The method of claim 2, further comprising accessing the database to determine elevation data for a different set of multiple positions that define a second area after the mobile station is moved to the second area.

5. The method of claim 1, wherein accessing a database to determine the elevation of the mobile station based on the determined position comprises accessing a server.

6. The method of claim 1, wherein the computer generated information comprises a location having a known position and an elevation and the computer generated information is displayed on the image further based on the known position and elevation of the location.

7. The method of claim 6, wherein the elevation of the location is determined by accessing a database and obtaining the elevation for the known position of the location.

8. The method of claim 1, further comprising determining an orientation of the mobile station when producing the image, wherein displaying the computer generated information on the image is further based on the determined orientation of the mobile station when producing the image.

9. The method of claim 8, wherein the orientation of the mobile station is determined using at least one of a magnetometer, an accelerometer, and a gyroscope.

10. The method of claim 1, wherein determining a position of a mobile station comprises determining the latitude and the longitude of the mobile station using a satellite positioning system.

11. The method of claim 1, wherein the computer generated information is displayed in response to a user request.

12. A mobile station comprising:
a satellite positioning system receiver that provides positioning data;
a camera that produces image data;
a wireless transceiver;
a processor connected to the satellite positioning system receiver to receive positioning data, the camera to receive the image data, and the wireless transceiver;
memory connected to the processor;
a display connected to the memory; and
software held in the memory and run in the processor to determine a latitude and a longitude of the mobile station based on the positioning data; and to control the wireless transceiver to obtain elevation data for multiple positions that define an area that includes the latitude and the longitude of the mobile station; and to calculate an elevation of the mobile station using the determined elevation data for the multiple positions; and to produce an image on the display based on the image data; and to produce computer generated information on the image displayed on the display, the vertical position of the computer generated information on the image is based on the calculated elevation of the mobile station.

13. The mobile station of claim 12, wherein the software is run in the processor to produce computer generated information that comprises a location having a known latitude, a known longitude and an elevation.

14. The mobile station of claim 13, wherein the software is run in the processor to control the wireless transceiver to obtain the elevation for the known latitude and known longitude of the location.

15. The mobile station of claim 12, further comprising a sensor that senses an orientation of the mobile station and provides sensor data, the processor is connected to the sensor to receive the sensor data, the software is run in the processor to determine the orientation of the mobile station, wherein the computer generated information is produced based on determined orientation of the mobile station.

16. The mobile station of claim 15, wherein the sensor comprises at least one of a magnetometer, an accelerometer, and a gyroscope.

17. The mobile station of claim 12, wherein the software is run in the process to calculate the elevation of the mobile station using bilinear interpolation.

18. A system for displaying an image along with computer generated information, the system comprising:
means for determining a current position;
means for determining elevation data for multiple positions that define an area that includes the current position;
means for calculating an elevation at the current position using the determined elevation data for the multiple positions;
means for producing an image; and
means for displaying computer generated information on the image, the vertical position of the computer generated information on the image is based on the calculated elevation of the mobile station.

19. The system of claim 18, wherein the computer generated information comprises a location having a known position and an elevation and the means for displaying computer generated information displays the computer generated information based on the known position and the elevation of the location.

20. The system of claim 19, wherein means for determining elevation data determines the elevation for the known position of the location.

21. The system of claim 18, further comprising means for determining an orientation of the system, wherein the means for displaying computer generated information displays the computer generated information based on the determined orientation of the system.

22. The system of claim 18, wherein means for calculating the elevation uses bilinear interpolation to calculate the elevation at the current position using the determined elevation data for the multiple positions.

23. A computer-readable medium including program code stored thereon, comprising:
program code to determine a current position;
program code to determine elevations for multiple positions that define an area that includes the current position;
program code to calculate an elevation of the current position using the determined elevations for the multiple positions;
program code to display an image; and
program code to display computer generated information on the image, the vertical position of the computer generated information on the image is based on the calculated elevation of the current position.

24. The computer-readable medium of claim 23, further comprising program code to determine an orientation of a camera when producing the image and to display the computer generated information on the image based on determined orientation of the camera.
